(19) United States
(12) Patent Application Publication
(10) Pub. No.: US 2011/0014996 A1
(43) Pub. Date: Jan. 20, 2011

(54) Higher performance golf club and attachment for golf club, golf ball, athletic shoes, and athletic shin guards using shear-thickening fluids

(75) Inventors: Robert Foster Shepherd, Champaign, IL (US); Travis Green, Fithian, IL (US)

Correspondence Address: Robert F. Shepherd, 17938 N 680 Rd, Fithian, IL, 61844, US

(73) Assignee: Liquid Glass Technologies, Incorporated

(21) Appl. No.: 12/460,406

(22) Filed: Jul. 17, 2009

(51) Int. Cl. A63B 53/04; H01F 41/06; B31B 1/60; B05D 3/00; A63B 37/12; A43B 5/00; A43B 23/00; A63B 71/12

(52) U.S. Cl. 473/349; 156/185; 156/60; 427/372.2; 473/378; 36/133; 12/142 P; 36/45; 2/22

(57) ABSTRACT

A method and system is provided which utilizes shear thickening fluids to enhance athletic performance. A shear thickening fluid composite is used on a golf club face to reduce the amount of side spin imparted onto a golf ball thus reducing the amount of slice or hook on the golf ball's flight path. Upon impact between the shear thickening fluid composite and the golf ball, the shear thickening fluid moves laterally away from the direction of the side spin imparted on the ball, thus reducing the amount of side spin imparted onto the golf ball. After this lateral motion, the shear thickening fluid hardens and transfers the remaining energy from the club face to the golf ball. A similar process occurs when the shear thickening fluid composite composes the outside of a golf ball. A shear thickening fluid composite is also used on an athletic shoe so as to transfer more force into a kicked ball thus having the ball travel at higher velocities. When the shoe strikes a ball, the shear thickening fluid within the shoe becomes rigid. This rigidness allows more energy to be transferred to the ball resulting in a ball traveling at a higher velocity. Additionally, a shear thickening fluid composite is incorporated into the sole of the athletic shoe to limit overpronation or underpronation during running. Also, a particulate-based shear thickening fluid incorporated into athletic shin guards improves protection and athletic performance by reducing weight and improving breathability.

### BACKGROUND OF THE INVENTION

The present invention generally relates to improved athletic equipment using shear thickening fluids.

A shear thickening fluid (also known as a dilatant fluid) is a fluid that increases in apparent viscosity as the rate of shear increases. This is in contrast to a Newtonian fluid (such as water) where the amount of shear rate achieved is directly proportional to the shear stress applied and the proportionality constant is the viscosity, where the viscosity does not vary over different shear rates. Thus, a shear thickening fluid is a non-Newtonian fluid where the shear stress is not directly proportional to the shear rate applied and where the apparent viscosity actually increases with higher shear stresses. At high enough shear rates the fluid becomes highly rigid. A shear rate may be defined in terms frequencies as measured in Hertz, or per second. In this manner, the higher the shear rate, the higher the frequency. Thus, by tuning the frequency response of the shear thickening fluid, the material may be programmed to display dilatants behavior at low or high frequencies. The rate of shear is simply the velocity of the object of the interest divided by the displacement of the object. Thereby, if the shear rate of the object of interest is known, a shear thickening fluid's response frequency may be tuned to its complement. A composite utilizing a shear thickening fluid may also be tuned to become rigid at a desired frequency. This tuning may be performed in particulate based shear thickening composites by altering the concentration of particles. Low particle concentrations demonstrate a higher frequency solid response while remaining fluid at lower frequencies. High particle concentrations demonstrate lower frequency response and thus become solid at lower shear rates.

This behavior is caused by the interactions between the particles and liquids in the fluid. Typically, at low shear rates a shear thickening fluid fills gaps between particles with liquid that acts as a lubricant and reduces the friction between the particles. However, at higher shear rates the liquid does not fill these gaps and the lack of a lubricant increases the friction between the particles and thereby causes an increase in apparent viscosity in a shear thickening fluid. There is also a jamming effect, whereby particles have less time to rearrange upon application of shear if the rate of shear exceeds the diffusion rate of the particles.

A useful result from these shear thickening fluid properties is when a shear stress is applied to a shear thickening fluid, the applied shear stress causes the shear thickening fluid to turn more solid-like and becomes more rigid. As soon as this shear stress is taken away, then the shear thickening fluid returns to its normal flexible resting state.

Shear thickening fluids have been used in materials worn by people. The shear thickening fluid is typically composed of particles or polymers suspended in a solvent. This shear thickening fluid is typically contained within a solid matrix to form a shear thickening fluid composite. A solid matrix is a material which keeps its shape without the aid of a container. An example of a solid matrix is a fabric formed from polymeric fibers or yarns.

Shear thickening fluids have been worn by people in several applications. For example, a design for body armor using a fabric impregnated with shear thickening fluids is disclosed in Wagner, U.S. Pat. No. 7,226,878. Wagner recites the use of fabric impregnated with shear thickening fluids to form a body armor that may offer the same protection as conventional body armors to protect police and soldiers' extremities from ballistic projectiles (e.g. bullets) while allowing for mobility. Wagner's fabric incorporates fibers made from either aramid, graphite, nylon, glass, or poly(paraphenylene terephthalamide) that are impregnated with a shear thickening fluid. The shear thickening fluid solvent is ethylene glycol, polyethylene glycol, silicone oil, or phenyltrimethicone (or combinations thereof) which contains particles of oxides, calcium carbonate, or other minerals (or combinations thereof) to form a shear thickening fluid. When impacted, this fabric dissipates the energy imparted by a ballistic projectile over a large area, thus shielding the wearer from harm.

Another design is for an energy absorbing composite using a solid polymer matrix containing a polymer-based dilatant is disclosed in Palmer et. al., U.S. Pat. No. 7,381,460. Palmer teaches the formation of shear thickening fluid based composite that is composed of a solid polymer or closed cell foam matrix with a polymer-based dilatants distributed throughout the matrix. Palmer teaches that this material may conform to the shape of what is intended to be protected and upon impact from a force turns rigid and both reduces the force impacted and spreads the area over which the force acts on to decrease the pressure. Palmer teaches that the composite may be used as protective clothing for humans, such as in helmets, or protective clothing for elbows, knees, hips, and shins, and parts of the body used to strike an object such as running shoe soles, football boots, and boxing gloves. However, Palmer's application uses only polymer-based dilatants and not non-polymer based dilatants. In addition, Palmer teaches the use of a shear thickening fluid composite only to protect the wearer from impacts, which requires the composite to become rigid at low frequencies and thus increasing the chances the composite becomes rigid when an impact does not occur, such as in rigorous sports play. In addition, Palmer's energy absorbing composite has a relatively low tensile strength thus requiring more composite to protect the wearer, thus adding more weight for the wearer to carry.

Turning now to golf, many people enjoy the game of golf. Often times, golfers hit a golf ball squarely to create a straight shot—where the club face is perpendicular to the desired straight path upon impact with the golf ball causing the ball to go straight. Unfortunately many amateur golfers struggle with trying to hit shots that go straight but are often unsuccessful. Often times, golfers who do not hit the ball straight find that a non-straight shot takes distance away from their shot and may leave their ball in an undesirable location such as behind a tree, inside a sand bunker, or in a water hazard. Often times this off-course path taken by the golf ball is caused by side spin imparted on the golf ball at impact. This side spin creates a lower zone of pressure on the side of the ball in which the ball is rotating while higher pressure occurs on the side of the ball away from the rotation, causing a pressure differential to push the ball in the direction of the spin as explained in Bernoulli's principle. This pushing thus causes the ball to veer away from a straight path.

This side spin is created in several different ways. For instance, when the golf club head is “open”—when the heel of the club head is in front of the toe of the club head and the ball is not hit squarely—the club head side of the club face hits the near side of the ball first, imparting a spin from left to right for a right-handed golfer (it is opposite for a left-handed golfer) causing the golf ball to curve to the right during its flight path, or slice. A slice may also be created when a club head path goes from outside in, no matter how squarely the ball is hit, because the club-path motion still imparts the left to right spin on the golf ball. A hook is the opposite of the slice. One way a hook occurs is when the toe side of the club face hits the far side of the ball first, imparting a right to left spin for a right-handed golfer (it is opposite for a left-handed golfer) causing the golf ball to curve to the left during its flight path. Similar to a slice, a second way a hook may be created is when the club head path goes from the inside out—even if the club face impacts the ball squarely—imparting the right to left spin which causes the golf ball to hook left.

To reduce this side spin and thereby reducing the slicing or hooking on the golf ball, Sheets et. al., U.S. Pat. No. 6,676,535, teaches a design where a golf club head's center of gravity is lower than the geometric center of the club head. This low and deep center of gravity causes the club head to impart less overall spin on the ball, which in turn reduces the amount of side spin imparted on the ball, thus reducing the slicing or hooking of the golf ball. Adams, U.S. Pat. No. 6,042,357, also teaches a design where the club head is weighted to reduce the side spin by adding more weight to the back heel area. However, the center of gravity within a golf club head may only be moved so much to reduce the amount of side spin imparted on a ball. In addition, adding excessive weight to a golf club may be undesirable as it may slow the speed of the golf swing thereby taking velocity off of the golf ball.

The selection of golf ball materials also influences the amount of spin imparted on a golf ball upon impact with a golf club. Golf balls are generally divided into two classes: one designed for more spin and the other designed for more distance. The balls designed for more spin are typically composed of three layers. The first layer is the central core, which may be made of liquid to produce the greatest amount of spin on the ball. The second layer is typically rubber windings that go around the liquid core. The outer layer is typically a soft substance such as balata or urethane. Professionals choose to play with these balls because they typically do not slice or hook (at least not on purpose, there are times professionals may choose to strategically put side spin on a ball) and they may use the spin to their advantage by putting backspin on the ball to pinpoint their approach shots to the pin.

The second class is the golf ball designed for more distance. These “distance balls” are typically made of two layers. The inner layer is typically a firm synthetic solid core. The outer layer is also firm, usually made from Surlyn. Because of the firmness of both the inner and outer layers, the ball travels a farther distance when struck. In addition, these balls do not spin as much as the “spin balls,” which lowers the amount of side spin imparted on the ball and the resulting slice or hook. Thus, these are balls of choice for the amateur golfer as their slower speeds are compensated for by the harder ball. In addition, amateur golfers may not take put high backspin on their balls and ball spin tends to hurt their game as they tend to impart side spin on the ball. Thus, less spin is generally desirable for the amateur golfer. The “distance balls” resistance to spinning is generated from the less “grip” or friction that is generated upon impact with the golf club.

An example of a golf ball design that aims to reduce spin on the golf ball by reducing the friction between the golf ball and golf club at impact is taught in Chang, U.S. Pat. No. 5,827,133. Chang teaches a golf ball where lubricant is diffused into the outer layer of the golf ball making the outside surface of the golf ball slippery. This lubricant reduces the friction and thereby less side spin is imparted onto the golf ball at impact. Chang also teaches a golf ball that that introduces a lubricating layer between the inner and outer layers of the golf ball, thus isolating the inner core of the golf ball from the spin imparted on the outer layer of the golf ball. Thus, less side spin translates into a golf shot that slices or hooks less.

Cavallaro, et al., U.S. Pat. No. 6,517,451 and Cavallaro, et al., U.S. Pat. No. 7,255,657 teach a golf ball composition that results in a golf ball that has a softer feel due to the soft cover and soft core all while maintaining a low level of spin. Cavallaro mentions in passing that dilatants fluids may be used in the ball coating. However, Cavallaro does not teach how this dilatant golf ball coating is advantageous over non-dilatant coated golf balls.

Moving beyond golf to other sports, many people enjoy participating in activities that puts their lower legs at risk of injury, including a fracture. For instance, in baseball a catcher must squat and catch pitches travelling potentially around 100 miles per hour and if they miss the baseball the potential of the baseball hitting the catcher's lower legs and injuring the lower leg is great. In addition, the umpire who stands behind the catcher is at risk of injuring their lower legs as well if the catcher fails to catch a pitch. In ice hockey players are constantly jockeying for the puck with their hockey sticks, and hockey sticks may and do strike other hockey players' lower legs. In addition, ice hockey players may take slap shots to the lower legs, thus opening up the potential for injury or even a fracture to the lower leg bones. Similar situations occur in field hockey, except with a ball instead of a puck. And there are many occasions where soccer players risk injuring their lower legs, for instance when two players try to kick the soccer ball at the same time, a soccer player collides with the goalkeeper, and one player slide tackles another.

There are two leg bones that constitute the lower leg. The tibia—or shin bone—is the larger one located anterior (i.e. in front) and is more vulnerable to fracture than other bones because it is exposed being in front of the leg and lacks protection from blows due to the absence of a cushioning muscle. The other lower leg bone is the fibula, which is smaller than the tibia and is located laterally to (i.e. behind) the fibula. Although the tibia is more protected than the fibula, injuries occur to the tibia in addition to the fibula. In order to protect their shins, people wear shin guards. In soccer, shin guards are presently made of various materials, including plastics, fiberglass, compressed air, and Kevlar. However, despite the use of shin guards, soccer players still sustain injuries to their lower legs and fractures to either their tibia or fibula even if the blow was dealt to the shin guard. Thus, improvements may be made to the strength of the shin guards to further protect soccer players' lower legs. However, the amount of material used to protect soccer players' shins is limited by other considerations such as “breathability” (the ability for air to permeate through the shin guard to aerate the players' legs) for comfort and weight for performance.

Shear thickening fluids have been applied to shin guards to improve the level of protection afforded to a soccer player. For example, a design for a shin guard utilizing shear thickening fluids is disclosed in Hayes et. al., U.S. Pat. No. 5,599,290 and Hayes et. al., U.S. Pat. No. 5,545,128. Hayes teaches the use of two strips that are placed in parallel with the tibia bone. However, this leaves significant portions of the shin and the rest of the lower leg exposed to injury for normal play in soccer.

Another example is the “d3o contour” shinguard by Sells Goalkeeper Products. The d3o contour shinguard is a shin guard made from a shear thickening fluid using a polymer-based dilatants as described in Palmer et. al. However, the polymer-based shear thickening fluid does not have a high tensile strength relative to other shear thickening fluids and thus more material must be added to the shin guard, adding more weight the athlete must carry. In addition, the polymer-based shear thickening fluid composite does not have high breathability, making the shin guard less comfortable for the athlete to wear. In addition, the d3o contour shin guard only protects the front of the lower leg, leaving the back of the lower leg susceptible to hits and collisions.

### BRIEF SUMMARY OF THE INVENTION

One or more of the embodiments of the present invention provide for improved athletic performance with the use of shear thickening fluids. Hitting a golf ball with a golf club face composed of a shear thickening fluid composite reduces the side spin imparted on a golf ball when the golf club face does not hit the golf ball squarely. Upon impact, the shear thickening fluid within the composite shifts laterally and inhibits side spin by deforming and making the impacted objects (club face and golf ball) impact planes more parallel, which reduces the amount of slicing or hooking. Post-impact and deformation, the composite becomes elastic/solid and transfers the remaining energy of impact between the club face and the ball. Using a shear thickening fluid composite for a golf ball cover also has the same effect of reducing the side spin imparted onto the golf ball.

An athletic shoe upper composed of a shear thickening fluid composite forms to the foot of the wearer. Upon kicking a ball, the force of the ball increases the shear rate upon the shoe upper and causes the shear thickening fluid in the upper to become rigid and transfers more force back into the ball to increase the velocity in the kicked ball (from 16-27 meters/second).

In addition, a shin guard with a particle-based shear thickening composite material improves upon shin guards using polymer-based shear thickening composite due to its lighter weight and improved breathability. Also, a shear thickening composite combined with an elastic which wraps around the lower leg protects both the front and the back of the lower leg from collisions unlike present shin guards.

### BRIEF DESCRIPTION OF THE DRAWINGS

FIG. 1 illustrates an elevational view of an improved golf club head utilizing a shear thickening fluid composite.

FIG. 2 illustrates an elevational view of an improved golf club head utilizing a shear thickening fluid composite.

FIG. 3 illustrates a perspective view of the golf club head utilizing a shear thickening fluid composite shown in FIG. 2.

FIG. 4 illustrates a flowchart for a method of reducing side spin imparted from a golf club using a shear thickening fluid composite.

FIG. 5 illustrates a cross-sectional view of an improved golf ball utilizing a shear thickening fluid composite.

FIG. 6 illustrates a flowchart for a method of reducing side spin imparted onto a golf ball composed of a shear thickening fluid composite.

FIG. 7 illustrates a plan view of an improved athletic shoe utilizing a shear thickening fluid composite.

FIG. 8 illustrates an elevational view of an improved athletic shoe utilizing a shear thickening fluid composite.

FIG. 9 illustrates an elevational view of an improved athletic shoe utilizing a shear thickening fluid composite.

FIG. 10 illustrates a flowchart for a method for kicking an athletic ball with more velocity.

FIG. 11 illustrates a perspective view of an improved athletic lower leg guard utilizing shear thickening fluid composites.

FIG. 12 illustrates a perspective view of an improved athletic shin guard utilizing a shear thickening fluid composite.

FIG. 13 illustrates a flowchart for a method for protecting the shin of an athlete.

### DETAILED DESCRIPTION OF THE INVENTION

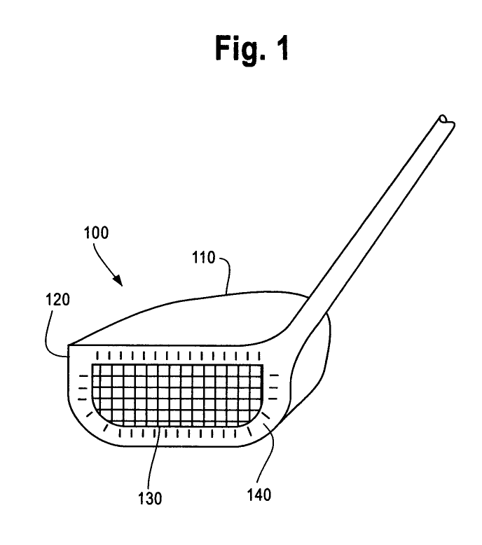

FIG. 1 illustrates a golf club 100 according to an embodiment of the present invention. The golf club 100 includes a golf club head 110, a golf club face 120, a shear thickening fluid composite 130, and epoxy 140. The shear thickening fluid composite 130 is affixed to the golf club face 120 by epoxy 140.

Prior to applying epoxy 140, the surface of the golf club face 120 may be roughened with an abrasive such as sand paper. In addition, small pegs may stick out of the golf club face 120 to give the epoxy 140 something to adhere to in addition to the shear thickening fluid composite 130.

The shear thickening fluid composite 130 is preferably composed of a fabric made from Kevlar that contains a shear thickening fluid composed of silica (i.e. silicon dioxide) particles preferably within the solvent ethylene glycol. The shear thickening fluid composite 130 can also be a concentrated emulsion of shear thickening fluid (i.e. silicon dioxide particles in ethylene glycol at high concentrations) suspended in an immiscible (i.e. poly(dimethyl siloxane)).

In operation, a golfer imparts side spin onto the golf ball. The shear thickening fluid within the shear thickening fluid composite 130 then becomes elastic and shifts laterally away from the direction of the side spin. This lateral shifting by the shear thickening fluid has the effect of at least partially counteracting the side spin imparted, thus reducing the amount of side spin the golf ball after contact with the shear thickening fluid composite 130. This reduction in the side spin of the golf ball results in less slicing or hooking for the shot.

Alternatively, the epoxy 140 may instead be an adhesive strong enough to affix the shear thickening fluid composite 130 to the golf club face 120. Also, the shear thickening fluid composite 130 may be affixed to the golf club face 120 by placing mechanical fasteners such as screws or nails through the shear thickening fluid composite 130 and into the golf club head 110. In addition, the shear thickening fluid composite 130 may be attached to the golf club head 110 with a bracing that holds the shear thickening fluid composite 130 against the golf club head 110.

Alternatively, the shear thickening fluid composite 130 may cover not only a certain portion of the golf club face 120 but also cover the entire golf club face 120. The shear thickening fluid composite 130 may also cover an area beyond the golf club face 120 to encompass a portion of the sides of the golf club head 110 to even encompassing the entire golf club head 110.

The shear thickening fluid composite 130 need not be made of a fabric-based matrix. The shear thickening fluid composite 130 may also be made from a shear thickening fluid coating that at least partially covers the club face 120. An example of a coating is a shear thickening fluid made from silica, polyacrylamide, and glycerol in a solvent such as water. Another example of a coating is a concentrated emulsion of shear thickening fluid made from silica, glycerol, and water blended into an immiscible matrix of silicone. A shear thickening fluid coating may even be affixed to the golf club face 120 by an adhesive.

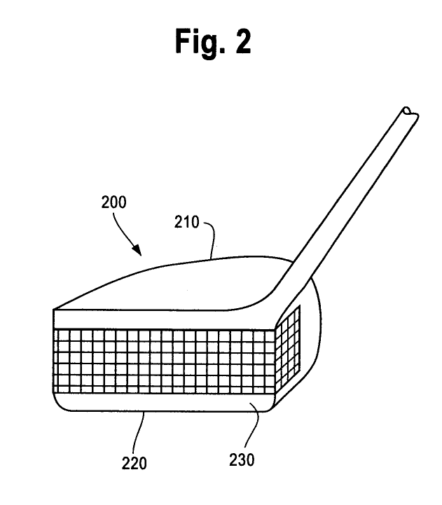

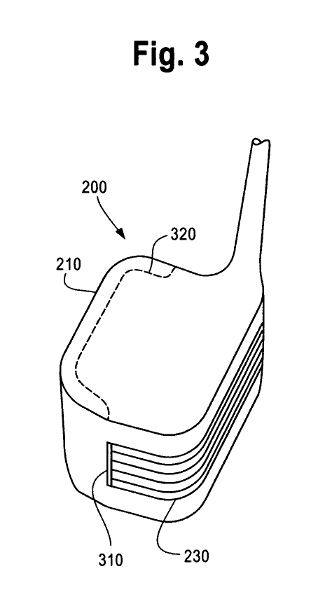

FIGS. 2 and 3 illustrate a golf club 200 according to another embodiment of the present invention. The golf club 200 includes a golf club head 210, a golf club face 220, and a shear thickening fluid composite ribbon 230. FIG. 3 further illustrates the golf club 200 of FIG. 2 by including an opening 310 and a ribbon path 320. The shear thickening fluid composite ribbon 230 wraps around the golf club head 210 and is inserted through the side of the golf club head 210 through opening 310. The ribbon 230 follows the path 320 through the golf club head 210. A pin in the back of the golf club head is then turned to tighten the ribbon 230 to the golf club face 220. The shear thickening fluid composite ribbon 230 is removable and thus may be replaced by a different shear thickening fluid composite ribbon 230.

The shear thickening fluid composite ribbon 230 is preferably composed of a fabric made from Kevlar that is impregnated with a shear thickening fluid composed of silica (i.e. silicon dioxide) particles within the solvent ethylene glycol. The shear thickening fluid composite ribbon 230 can also be an emulsion of shear thickening fluid in an immiscible matrix such as silicone or silicone rubber.

In operation, in a first situation, a golfer initiates their golf swing, but the golf swing is not completely accurate. Consequently, the golf club face 220 does not contact the ball squarely. The golf ball starts to be imparted with a side spin. In a second situation, the golfer initiates their golf swing, but the golfer swings the club either from the outside in or inside out, thereby cutting across the ball with the golf club face 220 and imparts a side spin onto the golf ball. In both situations, the shear thickening fluid within the shear thickening fluid composite 230 then shifts laterally away from the direction of the side spin. This lateral shifting by the shear thickening fluid has the effect of at least partially counteracting the side spin imparted, thus reducing the amount of side spin the golf ball has after contact with the shear thickening fluid composite 130. This reduction in the side spin of the golf ball results in less slicing or hooking for the shot.

The shear thickening fluid composite ribbon 230 is preferably removable so a golfer may replace the shear thickening fluid composite 230 with a different one with either similar or different properties. In a first scenario, a golfer may select a shear thickening fluid composite 230 that matches his or her skill level. Thus, a golfer who has a very severe slice may select a shear thickening fluid composite 230 that contains more shear thickening fluid. On the other hand, a golfer who has a slight slice (i.e. fade) may select a shear thickening composite 230 that contains less shear thickening fluid. And as a golfer improves his game, he may replace his existing shear thickening fluid composite ribbon 230 with a shear thickening composite 230 that has less shear thickening fluid. In addition, as a golfer's swing gets faster or slower, the golfer may wish to use a shear thickening fluid composite 230 that turns rigid at a desired frequency to minimize the side spin imparted onto the golf ball. For example, a faster swing may use a higher frequency-tuned shear thickening fluid composite. In a second scenario where the shear thickening fluid composite 230 wears out, a golfer may simply replace it with a similar shear thickening fluid composite 230.

Alternatively, the shear thickening fluid composite ribbon 230 may wrap around the top and the bottom of the golf club head 210. Also, the ribbon 230 may go around the back of the golf club head 210 instead of going through the opening 310. In addition, a knob instead of a pin in the back of golf club head 210 may be used where a user may twist the knob to tighten the ribbons 310 or strings wrapped around it to securely affix the shear thickening fluid composite 230 to the golf club head 210.

Alternatively, in lieu of the tying the shear thickening fluid composite ribbon 230 around the golf club head 210 or through the opening 310, a bracing may be affixed to the golf club face 220 that holds the shear thickening fluid composite ribbon 230 to the golf club face 220. In this way, a user may just take off the bracing, take out the old shear thickening fluid composite, put in a new shear thickening fluid composite, and then reaffix the bracing.

Alternatively, the shear thickening fluid composite ribbon 230 need not be a ribbon. The shear thickening fluid composite need not wrap around the golf club head 210 or through opening 310. A shear thickening fluid composite piece may be affixed to the golf club face 220 by means of a bracing. The brace may then be removed and a new shear thickening fluid composite piece may be affixed to the golf club face 220 by the brace. In addition, a shear thickening fluid composite piece may be mechanically affixed to the golf club face 220 by use of fasteners, such as screws.

Alternatively, the shear thickening fluid composite selected for either shear thickening fluid composite 130 or shear thickening fluid composite ribbon 230 may be composed of other fabric materials. In addition to Kevlar, the fabric may be made of spinel, spectra, or other fibers. These other fibers may be polymeric fibers including aramid, nylon, polyethylene, polypropylene, polyvinyl alcohol fibers, or combinations of these fibers. Also, other non-polymeric fibers such as graphite and glass fibers may be used.

Alternatively, other shear thickening dilatants may be used other than the silica particles in shear thickening fluid composite 130 or shear thickening fluid composite ribbon 230. Other particles may be used, such as calcium carbonate. Other polymers, such as polystyrene or polymethylmethacrylate, may also be used though polymers with glass transition temperatures below room temperature are preferable. These materials may be used alone or in combination with other shear thickening materials. Any other material that may be used to achieve the shear thickening property may be used.

Alternatively, other solvents may be used other than ethylene glycol if the solvent is stable enough to utilize the shear thickening particles to exhibit shear thickening properties and may stay with the fabric chosen. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties. A low vapor pressure solvent is preferable to remain stable over long time periods.

Alternatively, a cover may be secured over the shear thickening fluid composite 130 on golf club 100 or the shear thickening fluid composite ribbon 230 on golf club 200 to protect the shear thickening fluid composite 130 or shear thickening fluid composite ribbon 230. The cover may be composed of a thin amorphous metal sheet that is flexible enough to flex into the shear thickening fluid composite and transfer the effects of the shear thickening fluid composite into the golf ball upon contact.

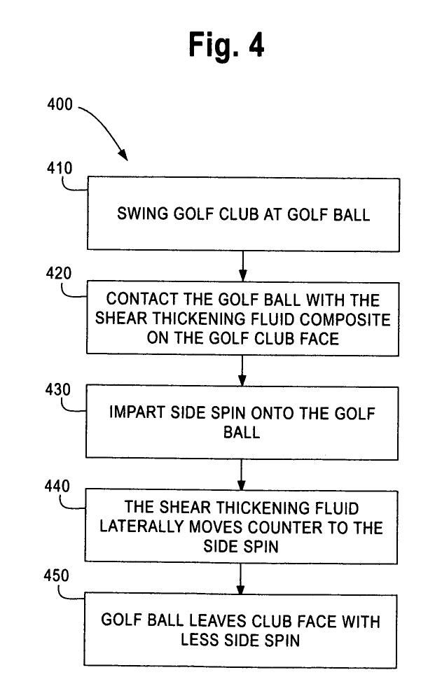

FIG. 4 illustrates a flow chart of a method of use 400 for either golf club 100 or golf club 200. The first step in the operation of the golf club 100 or golf club 200 is to swing the golf club 100 or golf club 200 at the golf ball 410. Then contact is made between the golf ball and the shear thickening fluid composite 130 on golf club 100 or the shear thickening fluid composite ribbon 230 on golf club 200 during the golf swing 420. This golf swing is not completely accurate and thus imparts side spin onto the golf ball 430.

When contacting the golf ball, the shear thickening fluid within the shear thickening fluid composite 130 or the shear thickening fluid composite ribbon 230 then moves laterally in the opposite direction of the spin imparted onto the golf ball, thus reducing the amount of side spin imparted on the golf ball 440. For instance, if the side spin imparted on the golf ball was from left-to-right, then the shear thickening fluid moves laterally to at least partially counter to the side spin from right-to-left, thereby reducing the left-to-right side spin. After the initial lateral movement, the shear thickening fluid composite becomes rigid to transfer the remaining energy from the club head 110 or club head 210 to the golf ball. Finally, the golf ball leaves the club face 120 on golf club 100 or the club face 220 on golf club 200 with less side spin 450. With less side spin, there is less slice or hook on the shot.

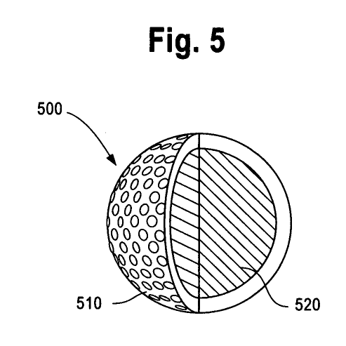

FIG. 5 illustrates a golf ball 500 according to an embodiment of the present invention. The golf ball 500 includes an outer layer 510 and a core 520. The core 520 is joined to the outer layer 510.

The golf ball cover 510 is preferably composed of a shear thickening fluid composite coating. This shear thickening fluid composite coating is preferably a blend of silica particles as the dilatant and polyethylene glycol as the polymer solvent. The golf ball core 520 is preferably made up of a typical core material, such as an ionomer.

The golf ball 500 is utilized when a golfer does not make an accurate golf swing, thus imparting a side spin onto the golf ball 500. The shear thickening fluid within the golf ball cover 510 then shifts laterally away from the direction of the side spin. This lateral shifting by the shear thickening fluid has the effect of counteracting the side spin imparted by the golf club, thus reducing the amount of side spin the golf ball 500 has after contact with the golf club face. This reduction in the side spin of the golf ball 500 results in less slicing or hooking for the shot.

Alternatively, the entire golf ball 500 may be composed of just one layer of a shear thickening composite. On the other hand, the golf ball 500 may be composed of multiple layers of differing materials, with the outside golf ball cover 510 still being composed of a shear thickening fluid composite. In addition, the golf ball core 520 may be made up of plastics, rubbers, liquids, or any combination thereof.

Alternatively, the shear thickening fluid composite selected for the golf ball 500 may be composed of fabric materials. The fabric may be made of Kevlar, spinel, spectra, or other fibers. These other fibers may be polymeric fibers including aramid, nylon, polyethylene, polypropylene, polyvinyl alcohol fibers, or combinations of these fibers. In addition, other non-polymeric fibers such as graphite and glass fibers may be used.

Alternatively, other shear thickening dilatants may be used in golf ball 500. Particles may be used, such as silica or calcium carbonate. Other polymers, such as polystyrene or polymethylmethacrylate, may also be used. These materials may be used alone or in combination with other shear thickening materials. Any other material that may be used to achieve the shear thickening property may be used.

Alternatively other solvents may be used other than ethylene glycol if it is stable enough to utilize the shear thickening particles to exhibit shear thickening properties and may stay with the fabric chosen. Solvents with a low enough vapor pressure to not evaporate while presenting a stable environment for the particles are preferable, such as silica. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties.

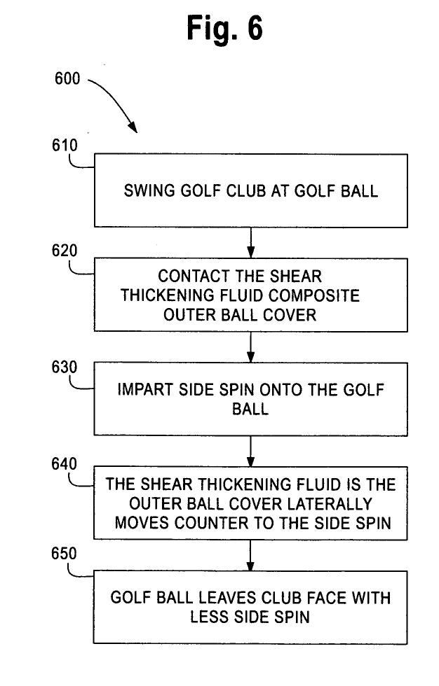

FIG. 6 illustrates a flow chart of a method of use 600 for golf ball 500. The first step in the operation of the golf ball 500 is to swing a golf club at the golf ball 500 with the intention to strike it 610. Then contact is made between the golf ball 500 and the golf club 620. This golf swing is not completely accurate and thus imparts side spin onto the golf ball 630.

When contacting the golf face, the shear thickening fluid within the shear thickening fluid composite in the golf ball cover 510 then moves laterally in the opposite direction of the spin imparted onto the golf ball, thus reducing the amount of side spin imparted on the golf ball 510 as compared to a golf club that is not composed of a shear thickening fluid composite 640. For instance, if the side spin imparted on the golf ball was from left-to-right, then the shear thickening fluid moves laterally to counter to the side spin from right-to-left, thereby reducing the left-to-right side spin. Finally, the golf ball leaves the club face on a golf club with less side spin 650. With less side spin, there is less slice or hook on the shot.

Alternatively, the golf ball 500 may be used in conjunction with the golf club 100 or golf club 200 in order to further reduce the side spin imparted on the golf ball 500. In this way, the shear thickening fluid in the shear thickening fluid composite 130 in golf club 100 and the golf club 200 and the shear thickening fluid composite ribbon 230 in golf club 200 moves laterally away to counter the spin that the golf club is imparting on the golf ball 500, and the shear thickening fluid within the golf ball cover 510 moves laterally away from the spin that is being imparted onto it by the golf club 100 or golf club 200.

The golf ball 500 presents an improvement over Chang because Chang does not teach how to counteract the spin imparted onto a golf ball by a golf club. The golf ball 500 also presents an improvement over Cavallaro because Cavallro does not teach how the shear thickening fluid within the golf ball works to counteract the spin imparted by a golf club.

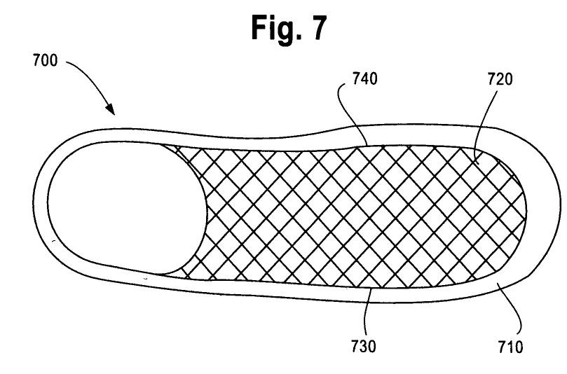

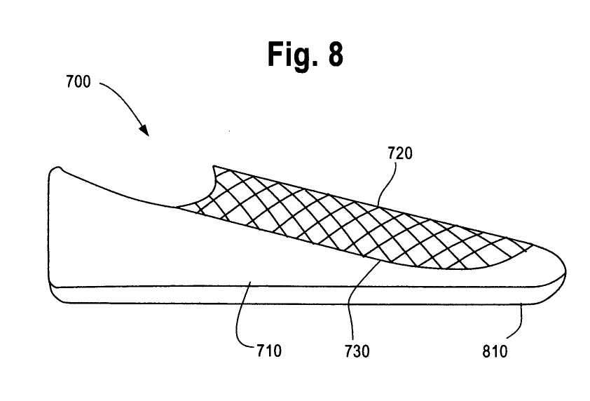

FIG. 7 illustrates an athletic shoe 700 according to an embodiment of the present invention. The athletic shoe 700 includes a shoe upper 710, a shoe cover 720, a seam 730, and a hook 740. FIG. 8 further illustrates athletic shoe 700 with sole 810. The hook 740 is attached to the shoe cover 720. The shoe cover 720 is attached to the shoe upper 710 along seam 730. The hook 740 hooks into the shoe upper 710. The shoe upper 710 is connected into the shoe sole 810.

The shoe cover 720 is preferably composed of a fabric made from Kevlar that is impregnated with a shear thickening fluid composed of silica (i.e. silicon dioxide) particles as the dilatant within the solvent ethylene glycol resulting in a shear thickening fluid composite. The shoe cover 720 can also be composed of a emulsion of concentrated shear thickening fluid (composed of silica in the solvent ethylene glycol) in poly(dimethyl siloxane) for example. The shoe cover 720 preferably covers the shoelaces used by the shoe 700 to tighten the shoe around the wearer's foot. The shear thickening fluid composite in the shoe cover 720 is also tuned to the frequencies associated with transferring as much energy into the ball as possible so as to have the ball leave the shoe 700 with more velocity.

In operation, the shoe cover 720 is initially not hooked to the shoe upper 710 exposing the shoelaces used to tighten the shoe 700 around the wearer's foot. The shoelaces are then tied and then the shoe cover 720 covers the shoelaces. The hook 740 then engages a latch found on the shoe upper 710 to securely attach the shoe cover 720.

Thus in operation, the shoe 700 is used to kick a ball with increased velocity in an athletic event such as soccer, rugby, or football. As the ball comes into contact with the shoe cover 720, the shear thickening fluid within the shoe cover 720 is subject to high shear stresses and frequencies. These high shear stresses and frequencies cause the shear thickening fluid to become more rigid on impact thus causing the shear thickening fluid to undergo a solid transition. This rigidness thus allows more energy to be transferred from the kick into the ball, thus causing the departing ball to travel with more velocity off of the shoe 700.

Alternatively, the shoe seam 730 may be any other methods of attachment—temporary or permanent—to the shoe 700, including but not limited to Velcro or a zipper. The shoe seam 730 may not even be attached but rather may be a continuous extension of the shoe upper 710. The shoe laces on the shoe 700 may also be another way of securing the shoe 700 around the wearer's foot, such as Velcro. The hook 740 may alternatively be any other method to temporarily secure the shoe cover 720 across the shoe 700, including a zipper, Velcro, or shoelaces. Also, the athletic shoe 700 may have cleats on the bottom of the sole 810 or may lack cleats.

Alternatively, the shear thickening fluid composite selected for the shoe cover 720 may be composed of other fabric materials. In addition to Kevlar, the fabric may be made of spinel, spectra, or other fibers. These other fibers may be polymeric fibers including aramid, nylon, polyethylene, polypropylene, polyvinyl alcohol fibers, or combinations of these fibers. In addition, other non-polymeric fibers such as graphite and glass fibers may be used.

Alternatively, other shear thickening dilatants may be used other than the silica particles in shoe cover 720. Other particles may be used, such as calcium carbonate. Other polymers, such as polystyrene or polymethylmethacrylate, may also be used. These materials may be used alone or in combination with other shear thickening materials. Any other material that may be used to achieve the shear thickening property may be used.

Alternatively, other solvents may be used other than ethylene glycol if it is stable enough to utilize the shear thickening particles to exhibit shear thickening properties and may stay with the fabric chosen. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties.

Palmer et. al, U.S. Pat. No. 7,381,460, teaches the use of shear thickening fluid composites in football boots. However, Palmer only teaches the use of these shear thickening fluid composites for protection for the wearer, which involves using low shear thickening fluid composite frequencies to achieve the solid transition. In addition, Palmer teaches only the use of polymer-based dilatants. The athletic shoe 700 represents an improvement over Palmer. Palmer teaches a football boot which is designed to protect the wearer from impacts. The frequency response required from the shear thickening fluid composite when kicking an athletic ball is higher than from impacts. Because of this higher frequency response, the chances the of the athletic shoe 700 becoming rigid when the rigidness is not needed during normal play is decreased.

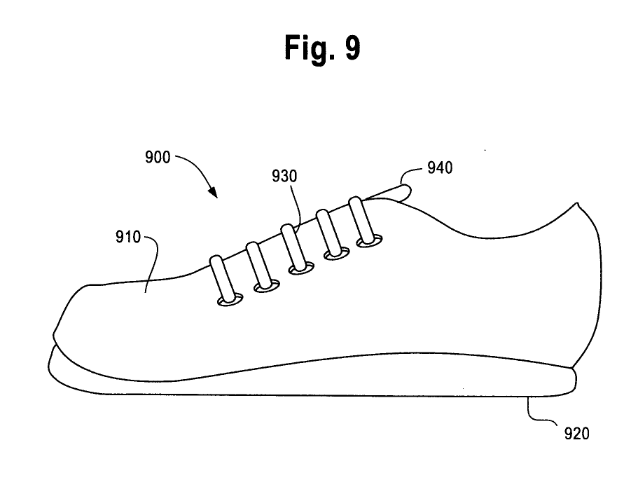

FIG. 9 illustrates an athletic shoe 900 according to an embodiment of the present invention. The athletic shoe 900 includes a shoe upper 910 composed at least partially of a shear thickening fluid composite, a sole 920, shoelaces 930, and shoe tongue 940. In the athletic shoe 900, the shoe tongue 940 is attached to the shoe upper 910. The shoelaces 930 thread through the shoe upper 910. The shoe tongue 940 is attached to the shoe upper 910. The shoe upper 910 is attached to the sole 920.

The shoe upper 910 is preferably composed of a fabric made from Kevlar that is impregnated with a shear thickening fluid composed of silica (i.e. silicon dioxide) particles within the solvent ethylene glycol resulting in a shear thickening fluid composite. The shoe upper 910 forms to the shape of the wearer's foot at rest because the shear thickening fluid composite is subject to low shear stresses and frequencies, thus enabling it to stay in a flexible fluid form. The shear thickening fluid composite is also tuned to turn rigid at the high frequencies associated with kicking an athletic ball, transferring as much energy into the ball as possible so as to have the ball leave the shoe 900 with more velocity.

Thus in operation, the shoe 900 is used to kick a ball with increased velocity in an athletic event such as soccer, rugby, or football. As the ball comes into contact with the shoe upper 910, the shear thickening fluid within the shoe upper 910 is subjected to shear stresses. These high shear stresses cause the shear thickening fluid within the shoe upper 910 to become more rigid on impact thus causing the shear thickening fluid to undergo a solid transition. This rigidness thus allows more energy to be transferred from the kick into the ball, thus causing the departing ball to travel with more velocity off of the shoe 900.

An alternative to having the whole shoe upper 910 being composed of a shear thickening fluid composite is excluding select portions of the shoe upper 910 to cut on costs or other reasons. For instance, the heel portion may be chosen not to be composed of a shear thickening fluid composite. In addition, the toe of the shoe upper 910 may be selected not to be composed of a shear thickening fluid composite. The shoe 900 may have cleats on the bottom of the sole 920 or may lack cleats.

Alternatively, other embodiments of the shoe 900 may have other parts outside of the shoe upper 910 containing shear thickening fluids to enhance the performance of the shear thickening fluid composite in the shoe upper 910. For example, the shoelaces 930 may contain shear thickening fluids. The shoe tongue 940 may also be made from a shear thickening fluid composite, especially if the shoe tongue 940 is lengthened to extend down the length of the shoe 900 to cover the shoelaces 930. In addition, the shoelaces 930 may be replaced by Velcro and the Velcro may be composed of a shear thickening fluid composite. Or a cover composed of a shear thickening fluid composite may be used to go over the parts of the shoe 900. The sole of the shoe 920 may also contain a shear thickening fluid composite around the edges or other portions of the shoe sole 920 to limit overpronation or under pronation during running. This shear thickening sole component can also be applied to other athletic training shoes.

Alternatively, the shear thickening fluid selected may be composed of other fabric materials. In addition to Kevlar, the fabric may be made of spinel, spectra, or other fibers. These other fibers may be polymeric fibers including aramid, nylon, polyethylene, polypropylene, polyvinyl alcohol fibers, or combinations of these fibers. In addition, other non-polymeric fibers such as graphite and glass fibers may be used. In addition an emulsion of shear thickening fluid in an immiscible solid matrix such as poly(dimethyl siloxane) may also be used.

Alternatively, other shear thickening dilatants may be used other than the silica particles. Other particles may be used such as calcium carbonate. Other polymers, such as polystyrene or polymethylmethacrylate, may be used. These materials may be used alone or in combination with other shear thickening materials. Any other materials that achieve the desired shear thickening properties may be used.

Alternatively, other solvents may be used other than ethylene glycol if it is stable enough to utilize the shear thickening particles to exhibit shear thickening properties and may stay with the fabric chosen. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties.

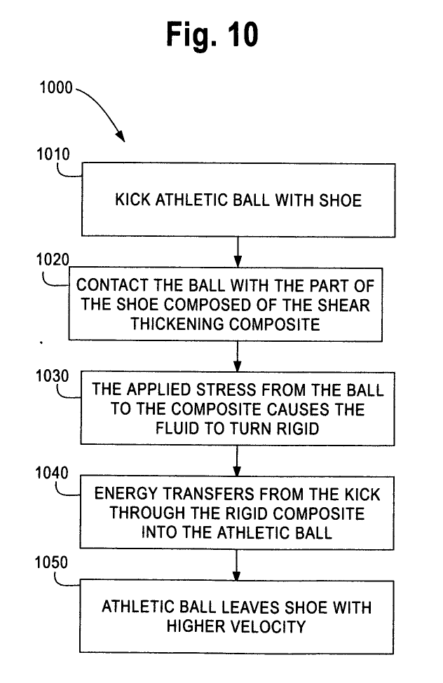

FIG. 10 illustrates a flow chart of a method of use 1000 for either athletic shoe 700 or athletic shoe 900. The athlete initiates the method by kicking the athletic ball with an athletic shoe 700 or athletic shoe 900 on his or her foot 1010. The athlete makes contact with the ball with the part of the athletic shoe 700 or athletic shoe 900 that is composed of the shear thickening composite 1020. In the case of athletic shoe 700, the shoe cover 720 makes contact with the athletic ball. In the case of athletic shoe 900, the shoe upper 910 makes contact with the athletic ball, or in the case of alternative embodiments, the shoelaces 930, the shoe tongue 940, or a shoe cover composed of a shear thickening fluid composite makes contact with the ball.

The contact between the athletic ball and the athletic shoe 700 or athletic shoe 900 applies stress to the shear thickening fluid composite. The shear thickening composite is tuned to undergo the solid transition to become more rigid at the appropriate frequency, which is higher than the frequency required to undergo a solid transition for protection purposes. Thus, at this higher frequency the shear thickening fluid within the composite turns rigid 1030. Then energy transfers from the kick, through the rigid shear thickening fluid composite, and then transfers into the athletic ball 1040. With this more efficient transfer of energy into the athletic ball due to the rigid shear thickening fluid composite, the athletic ball leaves the athletic shoe 700 or athletic shoe 900 with a higher velocity than a shoe that is not composed of a shear thickening fluid composite 1050. This increased velocity may be about 16-27 meters per second.

Alternatively, the athletic ball may be any ball that is kicked. These balls may include, but are not limited to, soccer balls, rugby balls, and footballs.

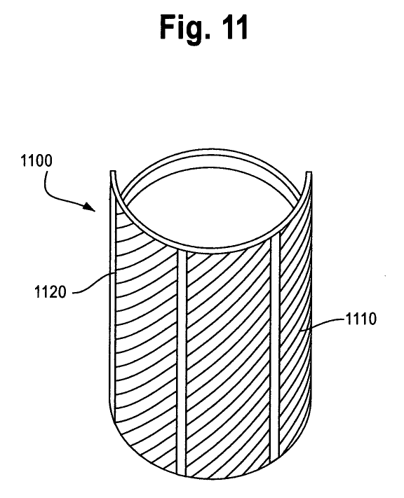

FIG. 11 illustrates a lower leg guard 1100 according to an embodiment of the present invention. The lower leg guard 1100 includes a plurality of shear thickening fluid composite strips 1110 and a plurality of elastic strips 1120. Each shear thickening fluid composite strip 1110 is attached to an elastic strip 1120 which in turn is connected to a shear thickening fluid composite strip 1110 such that each shear thickening composite strip 1110 alternates with each elastic strip 1120 around the entire circumference of the lower leg guard 1100.

The plurality of shear thickening fluid composite strips 1110 are preferably composed of a fabric made from Kevlar containing a shear thickening fluid composed of silica particles as the dilatant within the solvent ethylene glycol resulting in a shear thickening fluid composite. The elastic strips 1120 are preferably composed of spandex.

In operation, an athlete stretches open the lower leg guard 1100. The elastic strips 1120 stretch and allows the athlete to insert his foot and then his leg through the lower leg guard 1100. The athlete then places the lower leg guard 1100 around his shin and calf. As there is low stress applied to the shear thickening fluid composite strips 1110, the lower leg guard 1100 forms to the contours of the athlete's leg.

In operation, an object or another player collides with the lower leg guard 1100. As the collision takes place, stress is applied to the shear thickening fluid composite strips 1110. This stress causes the shear thickening fluid within the shear thickening fluid composite strips 1110 to undergo a solid transition and become more rigid. As the shear thickening fluid composite 1110 becomes more rigid, the applied force from the collision is spread out over a larger area from the point of impact, thus dampening the applied force and protecting the wearer from potential injury.

Because the shear thickening fluid composite strips are located around the whole circumference of the lower leg guard 1100, not only is the shin protected but also the back of the leg is also protected from collisions with other players.

Alternatively, the elastic 1120 may be any fabric that is capable of stretching, such as nylon. In addition, instead of having strips of alternating shear thickening fluid composite strips 1110 and elastic strips 1120, the lower leg guard may be made of a continuous piece of a shear thickening fluid composite with an elastic strip joining the ends of the shear thickening fluid composite piece. In order to increase the comfort of wearing the lower leg guard 1100, a layer of fabric may be used to line the inside the lower leg guard 1100. This fabric may be made of polymer or foam such as polyurethane.

Alternatively, the shear thickening fluid selected may be composed of other fabric materials. In addition to Kevlar, the fabric may be made of spinel, spectra, or other fibers. These other fibers may be polymeric fibers including aramid, nylon, polyethylene, polypropylene, polyvinyl alcohol fibers, or combinations of these fibers. In addition, other non-polymeric fibers such as graphite and glass fibers may be used.

Alternatively, other shear thickening dilatants may be used other than the silica particles. Other particles may be used such as calcium carbonate. Other polymers, such as polystyrene or polymethylmethacrylate, may be used. These materials may be used alone or in combination with other shear thickening materials. Any other materials that achieve the desired shear thickening properties may be used.

Alternatively, other solvents may be used other than ethylene glycol if the solvent is stable enough to utilize the shear thickening particles to exhibit shear thickening properties and may stay with the fabric chosen. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties.

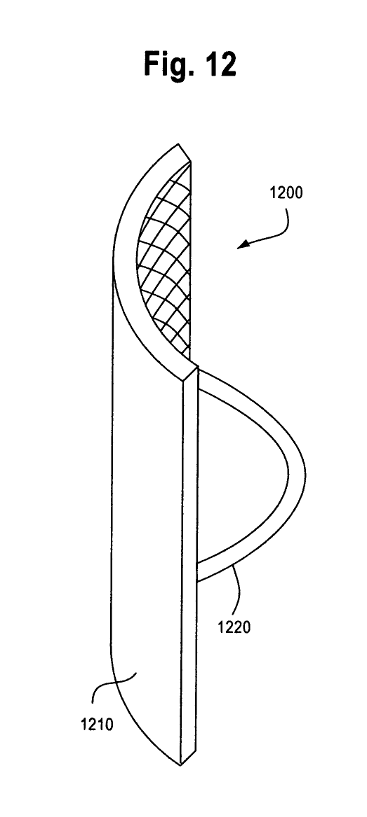

FIG. 12 illustrates a shin guard 1200 according to an embodiment of the present invention. The shin guard 1200 includes a shear thickening fluid composite shield 1210 and a strap 1220. The strap 1220 is attached to the shear thickening fluid composite shield 1210.

The shear thickening fluid composite shield 1210 is preferably composed of a fabric made from Kevlar that contains a shear thickening fluid composed of silica particles as the dilatants within the solvent ethylene glycol resulting in a shear thickening fluid composite. The strap 1220 is preferably composed of spandex. Because the shear thickening fluid composite is composed of a Kevlar fabric with particles as the dilatants instead of polymers as taught in Wagner et al. and used in the d3o countour shinguard, it has a higher tensile strength than Wagner's polymer-based shear thickening fluid composite. Thus, less material is needed for making the shin guard than the polymer-based shin guard. Also, because Kevlar is more permeable for air than the polymer-based shear thickening fluid composite and because less material is needed, the shin guard 1200 allows more air to reach the athlete's shin, thereby increasing comfort for the athlete.

In operation, an athlete stretches open the strap 1220. The athlete then inserts his leg through the shin guard 1200. The athlete lets go of the strap 1220 and the shear thickening fluid composite shield 1210 covers the front of the athlete's leg while the strap 1220 goes around the athlete's leg. Because there is low stress applied to the shear thickening composite shield 1210, the shear thickening fluid composite shield 1210 forms to the contours of the athlete's front leg.

In operation, an object or another player collides with the shin guard 1200. As the collision takes place, stress is exerted onto the shear thickening fluid composite shield 1210. This stress causes the shear thickening fluid within the shear thickening fluid composite shield 1210 to undergo a solid transition and becomes more rigid. As the shear thickening fluid composite 1210 becomes more rigid, the applied force from the collision is spread out over a larger area from the point of impact, thus dampening the applied force and protecting the wearer from potential injury.

Alternatively, a plurality of straps may be used instead of just one strap 1220. In addition, to increase the comfort of wearing the shin guard 1200, a layer of non-shear thickening fluid fabric may be used to line the inside area of the shin guard 1200. This fabric may be made of polymer or foam such as polyurethane. In addition, the width of the shear thickening fluid composite shield 1210 may vary from being narrow enough to cover the athlete's shin to being wide enough to cover most of the circumference of the athlete's lower leg.

Alternatively, the shear thickening fluid selected may be composed of other fabric materials. In addition to Kevlar, the fabric may be made of spinel, spectra, or other fibers. These other fibers may be polymeric fibers including aramid, nylon, polyethylene, polypropylene, polyvinyl alcohol fibers, or combinations of these fibers. In addition, other non-polymeric fibers such as graphite and glass fibers may be used.

Alternatively, other shear thickening particle dilatants may be used other than the silica particles. Other particles may be used such as calcium carbonate. These materials may be used alone or in combination with other shear thickening materials. Any other dilatants that achieve the desired shear thickening properties may be used.

Alternatively, other solvents may be used other than ethylene glycol if the solvent is stable enough to utilize the shear thickening particles to exhibit shear thickening properties and may stay with the fabric chosen. Water or a water-based solvent may be used. Organic solvents such as ethanol or polyethylene glycol may be used. Silicon-based solvents such as oils or phenyltrimethicone may be used. These materials may be used alone or in combination with other solvents to achieve the desired shear thickening properties.

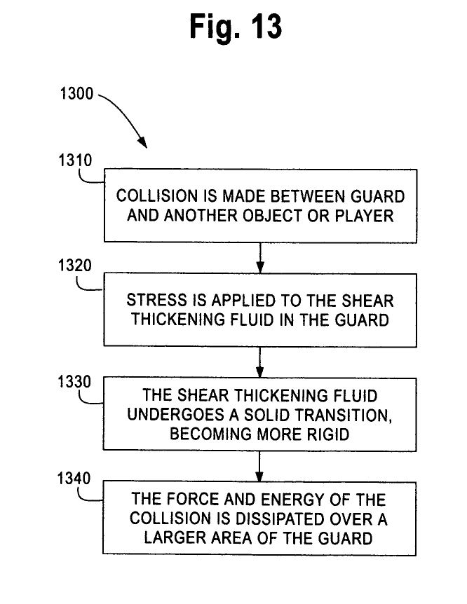

FIG. 13 illustrates a flow chart of a method of use 1300 for either lower leg guard 1100 or shin guard 1200. The method is initiated when a collision is made between the lower leg guard 110 or shin guard 1200 and another object or player 1310. When this collision occurs, the force of the collision applies a stress to the shear thickening fluid found within the lower leg guard 1100 or the shin guard 1200 at the point of impact 1320. This rapidly applied stress to the shear thickening fluid causes the fluid to undergo a solid transition, causing the fluid to become more rigid 1330. Due to this solid transition, more of the force and energy of the collision is contained within the lower leg guard 1100 or shin guard 1200 and not through into the athlete's leg, but instead is dissipated over a larger area thus protecting the user from potential injury 1340.

Alternatively, the type of collisions the lower leg guard 1100 and shin guard 1200 vary according to use and the shear thickening fluid composites are tuned to the appropriate frequency response. The shear thickening fluid composites may be tuned for soccer, where field players kick each other while attempting to go for the soccer ball, collisions occur between field players and the goalkeeper, and slide tackles cause collisions with the lower leg guard 1100 or shin guard 1200. The shear thickening fluid composites may be tuned for use in baseball, where a catcher's and home plate umpire's lower leg guard 1100 or shin guard 1200 may be tuned to withstand direct blows from high velocity fastballs thrown from the pitcher. The shear thickening fluid composites may also be tuned for use in hockey, where the lower leg guard 1100 or shin guard 1200 may be tuned to protect the athlete from blows from slap shots and hockey stick hits. The lower leg guard 1100 and shin guard 1200 may also protect the wearer in the martial arts.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed is:

1. A shear thickening fluid enhanced golf club, said golf club including:
a golf club head, wherein said golf club head has a face portion,
wherein said face portion contacts a golf ball during a typical golf swing; and
a shear thickening fluid composite, wherein said shear thickening fluid composite is positioned over said face portion so that said shear thickening fluid composite, rather than said face portion, contacts said golf ball during a golf swing.

2. The golf club of claim 1 wherein said shear thickening fluid composite is a ribbon that wraps around said golf club head.

3. The golf club of claim 1 wherein said shear thickening fluid composite is affixed to said golf club head.

4. The golf club of claim 1 wherein said shear thickening fluid composite includes a solid matrix material.

5. The golf club of claim 1 wherein said shear thickening fluid composite contains dilatants that are not polymeric-based.

6. The golf club of claim 4 wherein said solid matrix material is composed of a fabric.

7. The golf club of claim 6 wherein said fabric base material is Kevlar.

8. The golf club of claim 1 wherein said shear thickening fluid composite is detachable from said golf club head.

9. The golf club of claim 1 further including a shear thickening fluid composite cover, wherein said shear thickening fluid composite cover is positioned over said shear thickening fluid composite so that said shear thickening fluid composite cover, rather than said shear thickening fluid composite, contacts said golf ball during a golf swing.

10. A method for modifying a golf club using shear thickening fluids, said method comprising:
providing a golf club having a golf club head,
wherein said golf club head has a face portion,
wherein said face portion contacts a golf ball during a golf swing; and
positioning a shear thickening fluid composite, over said face portion so that said shear thickening fluid composite, rather than said face portion, contacts said golf ball during a golf swing.

11. The method of claim 10 wherein said shear thickening fluid composite is a ribbon, further including the step of wrapping said shear thickening fluid composite around said golf club head.

12. The method of claim 10 wherein said shear thickening fluid composite is a ribbon, further including the step of inserting said shear thickening fluid composite through said golf club head.

13. The method of claim 10 further including the step of affixing said shear thickening fluid composite to said golf club face.

14. The method of claim 10 wherein said shear-thickening fluid composite uses a non polymer based dilatant.

15. The method of claim 10 further including the step of positioning a shear thickening fluid composite cover over said shear thickening fluid composite, wherein said shear thickening fluid composite cover is positioned over said shear thickening fluid composite so that said shear thickening fluid composite cover, rather than said shear thickening fluid composite, contacts said golf ball during a golf swing.

16. A golf ball including an exposed layer, wherein said exposed layer is composed of a shear thickening fluid composite.

17. The golf ball of claim 16 wherein said golf ball contains a core layer.

18. The golf ball of claim 16 wherein said golf ball contains a plurality of layers.

19. The golf ball of claim 16 wherein said shear thickening fluid composite is composed of a non polymer based dilatant.

20. A method for modifying a golf ball using shear thickening fluids, said method comprising:
providing a golf ball; and
providing a layer over said golf ball, wherein said outer layer is composed of a shear thickening fluid composite so that said shear thickening fluid composite contacts a golf club during a golf swing.

21. A shear thickening fluid enhanced athletic shoe, said athletic shoe including a shoe cover, wherein said shoe cover is composed of a shear thickening fluid composite, wherein said shoe cover contacts an athletic ball during a kick.

22. The shoe of claim 21, wherein said shoe further includes a shoe tongue, wherein said shoe cover is an extension of said shoe tongue.

23. The shoe of claim 21, wherein said shoe is composed of a shoe upper, wherein said shoe cover is attached to said shoe upper.

24. The shoe of claim 23, wherein said shoe cover further includes a hook, wherein said hook latches onto said shoe upper.

25. The shoe of claim 23, wherein said shoe cover further includes Velcro, wherein said Velcro attaches onto said shoe upper.

26. The shoe cover of claim 23, wherein said shear thickening fluid composite further includes a solid matrix.

27. The shoe cover of claim 26, wherein said solid matrix is made from a fabric.

28. A method for modifying an athletic shoe using shear thickening fluids, said method comprising:
providing an athletic shoe; and
securing a shoe cover onto said athletic shoe, wherein said shoe cover is composed of a shear thickening fluid composite so that said shoe cover contacts an athletic ball during a kick.

29. The method of claim 28 wherein said athletic shoe further includes a shoe tongue, wherein said shoe cover is an extension of said shoe tongue.

30. A shear thickening fluid enhanced athletic shoe, said athletic shoe including a shoe upper, wherein said shoe upper is composed of a shear thickening fluid composite which turns rigid when kicking an athletic ball.

31. The shoe upper of claim 30 further including a tongue, wherein said tongue is composed of a shear thickening fluid composite.

32. The shoe upper of claim 30 wherein said shear thickening fluid composite is made from a solid matrix.

33. The shoe upper of claim 32 wherein said solid matrix is fabric.

34. The shoe upper of claim 33 wherein said fabric material is Kevlar.

35. The shoe upper of claim 30 wherein said shear-thickening fluid composite is composed of a non-polymeric dilatant.

36. The shoe upper of claim 35, wherein said non-polymeric dilatant is silica.

37. A shear thickening fluid enhanced lower leg guard, said lower leg guard including:
at least one piece of shear thickening fluid composite; and
at least one piece of elastic material, wherein said elastic material joins the sides of at least one said shear thickening fluid composite piece.

38. The lower leg guard of claim 37, further consisting of a plurality of shear thickening fluid composite pieces; and a plurality of elastic material pieces, wherein said shear thickening fluid composite pieces and said elastic material pieces alternate around the circumference of the lower leg guard.

39. The lower leg guard of claim 37, wherein said shear thickening fluid composite is comprised of Kevlar fiber.

40. The lower leg guard of claim 37, wherein said shear thickening fluid composite is comprised of silica particles.

41. The lower leg guard of claim 37, wherein said elastic material is spandex.

42. A shear thickening fluid enhanced shin guard, said shin guard including a shield comprised of a non-polymer based shear thickening fluid composite.

43. The shin guard of claim 42 further including a strap.

44. The shin guard of claim 42 further including a non-shear thickening fluid liner.

45. The shin guard of claim 42 wherein said particle-based shear thickening fluid composite is composed of a Kevlar fabric.

46. The shin guard of claim 42 wherein said particle-based shear thickening fluid composite is composed of silica particles as a dilatant.
